(19) United States
(12) Patent Application Publication
(10) Pub. No.: US 2017/0207024 A1
(43) Pub. Date: Jul. 20, 2017

(54) MULTI-LAYER CERAMIC CAPACITORS WITH BOTTOM OR SIDE TERMINATIONS

(71) Applicant: Apple Inc., Cupertino, CA (US)

(72) Inventors: Paul A. Martinez, Morgan Hill, CA (US); Gang Ning, Santa Clara, CA (US); Curtis C. Mead, Sacramento, CA (US); Ming Y. Tsai, San Jose, CA (US); Albert Wang, Sunnyvale, CA (US)

(21) Appl. No.: 15/409,217

(22) Filed: Jan. 18, 2017

Related U.S. Application Data
(60) Provisional application No. 62/280,031, filed on Jan. 18, 2016.

(51) Int. Cl. H01G 4/30; H01G 4/40; H01G 4/224; H01G 4/008; H01G 4/228; H01G 4/012

(52) U.S. Cl. CPC H01G 4/30; H01G 4/228; H01G 4/012; H01G 4/224; H01G 4/008; H01G 4/40

(57) ABSTRACT

Methods and devices related to fabrication and utilization of multilayer capacitors presenting low equivalent series resistance (ESR) is illustrated. The capacitors may present electrodes that are coupled to metallic terminations at the bottom and/or at the side of the capacitor. The position of the electrode coupling may lead to smaller current paths in the MLCC electrode, which may decrease line inductances. Methods and systems for fabrication of the capacitors described are also discussed.

### CROSS-REFERENCE

This application claims the benefit of U.S. Provisional Application No. 62/280,031 entitled “METHODS FOR IMPROVING ELECTRICAL PERFORMANCE IN MULTI-LAYER CERAMIC CAPACITORS” filed on Jan. 18, 2016, which is incorporated by reference herein its entirety for all purposes.

### BACKGROUND

The present disclosure relates generally to design and fabrication of capacitor structures with improved electrical performance. More specifically, the disclosure discusses multilayer capacitor structures with bottom terminations that may present decreased current crowding and line inductance effects, which may result in decreased equivalent series resistance and a higher ratio of reactance to resistance (Q factor).

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Capacitors are often used in circuits designed for high frequency applications, such as in circuits for wireless radio frequency (RF) circuitry, impedance matching circuits, filters, resonator circuits, precision tank circuits, decoupling circuits, and other known applications. As a result, the performance of the circuits may improve when certain characteristics of the capacitor, such as equivalent series resistance (ESR) are improved. Usually, multilayer ceramic capacitors (MLCCs) may have electrical terminations that couple to the capacitor electrodes at the ends of the body of the capacitor device. This arrangement may increase the path of conductivity from the circuit board into the electrodes of the capacitor structures. Due to this elongated path, an increase in the ESR may appear due to current crowding and line inductance effects. These effects may reduce the effectiveness of the capacitor, particularly in circuits that may operate with high-frequency electrical signals.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Descriptions enclosed herein relate to multilayer ceramic capacitors that may have terminations disposed along the bottom of the device. The capacitors describe may be formed from ceramic sheets having stenciled vertical electrodes that may present tab structures located in a region that will be located in the bottom of the device. The tab structures may be electrically coupled to the above referred bottom terminations, which permit a short current path length between the electrodes and the substrate surface. As a result, higher Q factor, low ESR multilayer ceramic capacitors may be obtained. The descriptions enclosed also discuss other modifications to the capacitor electrode layout, such as the use of side extensions and/or notches to improve current path lengths, and a pitchfork layout to improve the flow of current along the electrode surface.

In one example, a capacitor may be described. The capacitor may have a first set of layers, each layer having an electrode. Each electrode in of the first set of layers may have a first tab structure that may be used to couple each electrode to a first termination. The capacitor may also have a second layer that is disposed between two layers of the first set of layers. The second layer may have a second electrode with a second tab that may be used to couple the second electrode to a second termination.

In another example, an electrical device is described. The electrical device may have an electrical circuit that employs a capacitor. The capacitor may have a first set of layers, each layer having a first electrode having a first tab at the bottom of the electrodes. These first tabs in the electrodes of the first set of layers may be used to couple the capacitor to a first termination located along the bottom of the capacitor. The capacitor may have also have a second set of layers, each layer having a second electrode having a second tab at the bottom of the electrodes. These second tabs in the electrodes of the second set of layers may be used to couple the capacitor to a second termination located along the bottom of the capacitor.

In another example, a method to fabricate MLCCs may be described. The method may have steps for stenciling a first ceramic sheet with a conductive material to produce a first electrode having a first tab. The method may also have steps to produce stenciling a second ceramic sheet with the conductive material to produce a second electrode with a second tab. The layout of the first electrode and that of the second electrode may be chosen to produce the appropriate capacitor coupling. The method may also have steps for stacking the ceramic sheets to form the capacitive coupling between the first and the second electrodes, and exposing the first and the second tabs at a bottom of the stack.

### BRIEF DESCRIPTION OF THE DRAWINGS

Various aspects of this disclosure may be better understood upon reading the following detailed description and upon reference to the drawings in which:

FIG. 1 is a diagram of an electrical device that may benefit from the inclusion of one or more low equivalent series resistance (ESR) capacitors, in accordance with an embodiment;

FIG. 2 is a perspective view of a notebook computer that may benefit from the inclusion of one or more low ESR capacitors, in accordance with an embodiment;

FIG. 3 is a front view of a hand-held device that may benefit from the inclusion of one or more low ESR capacitors, in accordance with an embodiment;

FIG. 4 is a front view of portable tablet computer that may benefit from the inclusion of one or more low ESR capacitors, in accordance with an embodiment;

FIG. 5 is a diagram of a desktop computer that may benefit from the inclusion of one or more low ESR capacitors, in accordance with an embodiment;

FIG. 6 presents a front and a side view of a wearable electrical device that may benefit from the inclusion of one or more low ESR capacitors, in accordance with an embodiment;

FIG. 7A presents a perspective view of a capacitor with extended bottom terminations that may be used in conjunction with any of the devices of FIGS. 1-6, in accordance with an embodiment;

FIG. 7B presents a partially exploded perspective view of a capacitor with extended bottom terminations of FIG. 7A, in accordance with an embodiment;

FIG. 7C presents an exploded perspective view of a capacitor with extended bottom terminations of FIG. 7A, in accordance with an embodiment;

FIG. 8A presents an exploded perspective view of a capacitor with extended bottom terminations and square bottom profile that may be used in conjunction with any of the devices of FIGS. 1-6, in accordance with an embodiment;

FIG. 8B presents a second exploded perspective view of the capacitor with extended bottom terminations of FIG. 8A, in accordance with an embodiment;

FIG. 8C presents a bottom view of the capacitor with extended bottom terminations of FIG. 8A;

FIG. 9A presents an exploded view of a capacitor with bottom only terminations that may be used in conjunction with any of the devices of FIGS. 1-6, in accordance with an embodiment;

FIG. 9B presents a bottom view of the capacitor with bottom only terminations of FIG. 9A, in accordance with an embodiment;

FIG. 10A presents a perspective view of a capacitor with bottom and side terminations that may be used in conjunction with any of the devices of FIGS. 1-6, in accordance with an embodiment;

FIG. 10B presents a front view of the capacitor with bottom and side terminations of FIG. 10A, in accordance with an embodiment;

FIG. 10C presents a bottom view of the capacitor with bottom and side terminations of FIG. 10A, in accordance with an embodiment;

FIG. 10D presents an exploded view of the capacitor with bottom and side terminations of FIG. 10A, in accordance with an embodiment;

FIG. 11A presents a perspective view of a capacitor with multiple bottom terminations that may be used in conjunction with any of the devices of FIGS. 1-6, in accordance with an embodiment;

FIG. 11B presents a bottom view of the capacitor with multiple bottom capacitor of FIG. 11A, in accordance with an embodiment;

FIG. 11C presents an exploded perspective view of the capacitor with multiple bottom terminations of FIG. 11A, in accordance with an embodiment;

FIG. 11D presents an exploded front view of the capacitor with multiple bottom terminations of FIG. 11A, in accordance with an embodiment;

FIG. 11E presents an exploded front view with electrode details for the capacitor with multiple bottom terminations of FIG. 11A, in accordance with an embodiment;

FIG. 12A illustrates a first electrode that may be used in the capacitor with multiple bottom terminations of FIG. 11A, in accordance with an embodiment;

FIG. 12B illustrates a second electrode that may be used to form capacitive coupling with the electrode illustrated in FIG. 12A to form the capacitor with multiple bottom terminations of FIG. 11A, in accordance with an embodiment;

FIG. 13A illustrates a capacitor formed employing L-shaped electrodes that may be used to form a capacitor with bottom terminations that may be used in conjunction with any of the devices of FIGS. 1-6, in accordance with an embodiment;

FIG. 13B illustrates a first electrode that may be used to form the capacitive interface illustrated in FIG. 13A, in accordance with an embodiment;

FIG. 13C illustrates a second electrode that may be used to form with the electrode of FIG. 13B the capacitive interface illustrated in FIG. 13A, in accordance with an embodiment;

FIG. 14A illustrates a capacitor formed employ notched L-shaped electrodes that may be used to form a capacitor with bottom terminations that may be used in conjunction with any of the devices of FIGS. 1-6, in accordance with an embodiment;

FIG. 14B illustrates a first notched L-shaped electrode that may be used to form the capacitive interface illustrated in FIG. 14A, in accordance with an embodiment;

FIG. 14C illustrates a second notched L-shaped electrode that may be used to form with the electrode of FIG. 14B the capacitive interface illustrated in FIG. 14A, in accordance with an embodiment; and

FIG. 15 illustrates a method to produce a capacitor that may be used to form any of the capacitive structures illustrated in FIG. 7A, 8A, 9A, 10A, 11A, 13A, or 14A, in accordance with an embodiment.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the phrase A “based on” B is intended to mean that A is at least partially based on B. Moreover, the term “or” is intended to be inclusive (e.g., logic OR) and not exclusive (e.g., logic XOR). In other words, the phase “A or B” is intended to mean A, B, or both A and B.

In some of the descriptions, we may employ the terms “coupling” and “connected” between two devices. Terms such as “coupled” and “electrically coupled” are intended to mean that the two devices may form an electrical circuit of some kind while “directly coupled” or “directly connected” is intended to mean that there is a physical connection between the two devices. “Resistively coupled” is intended to mean that the two devices are electrically coupled and that the type of electrical circuit formed between the two devices is substantially a resistive circuit, whereas “capacitive coupled” is intended to mean that there is at least one capacitive interface (e.g., a dielectric capable of storing electric potential) in the circuit. Moreover, expressions such as “coupling through a connector” are intended to mean that the circuit between the two devices includes the connector. Terms such as “operably coupled” are intended to mean that the two devices may be coupled in a manner that allows for proper function of the devices.

The disclosed embodiments relate to systems and devices for the design and fabrication of capacitors structures presenting electrodes that may have bottom and/or bottom and side terminations. The capacitors may be constructed with techniques such as those used in forming multilayer ceramic capacitors (MLCC) to form electrodes separated by a dielectric. The electrodes may be electrically coupled to metallic terminations formed in the body of the capacitors.

In certain situations, coupling of the electrodes to the metallic terminations may take place at the ends of the body of the capacitor. Since the coupling between the capacitor and the printed circuit board may take place at the bottom of these metallic terminations, the current path of the charges going from the printed circuit to the MLCC electrodes may lead to inefficiencies. For example, the arrangement may lead to current crowding due to strangulation points in the current path. In some situations, higher line inductance due to a presence of multiple current paths with different lengths may appear. As a result, MLCCs having terminations coupled to electrodes on ends of the bodies of the capacitor may have higher equivalent series resistance (ESR) and/or low Q factor (i.e., low ratio of reactance to resistance in the capacitor).

Embodiments described herein are related to MLCC capacitors having electrodes that may benefit from terminations that are coupled to electrodes at the bottom of the capacitor structure. The electrodes employed may have “tab” structures in the regions at the bottom of the capacitor to couple with the metallic terminations. Since the metallic terminations are coupled to the PCB at the bottom, these tab structures allow a direct path for the current coming from the PCB into the electrodes. This feature may substantially reduce current crowding during entry into the electrode and reduce the ESR, when compared to capacitor designs having terminations on the end of the capacitor structure.

Embodiments may also include metallic terminations that extend from the bottom into the side of the electrodes. These terminations may increase the cross-section area available for the flow of charge carriers into and out of the electrodes, which may further decrease the ESR. In some applications, the side portion of the metallic terminations may couple to fillet-shaped soldering that further increase the cross-section area for the flow of charges. Certain embodiments may also include pitchfork-shaped electrodes that may provide an orientation for electrode surface currents during operation of the capacitor structure. As discussed in detail below, pitchfork features may decrease further the line inductances in the electrode surfaces as well as generate cancelling mutual inductances, leading to a higher Q factor capacitor. The improved electrical characteristics of the capacitors described herein may lead to improvement in the performance of electrical devices and systems, particularly in situations that employ high-frequency signals.

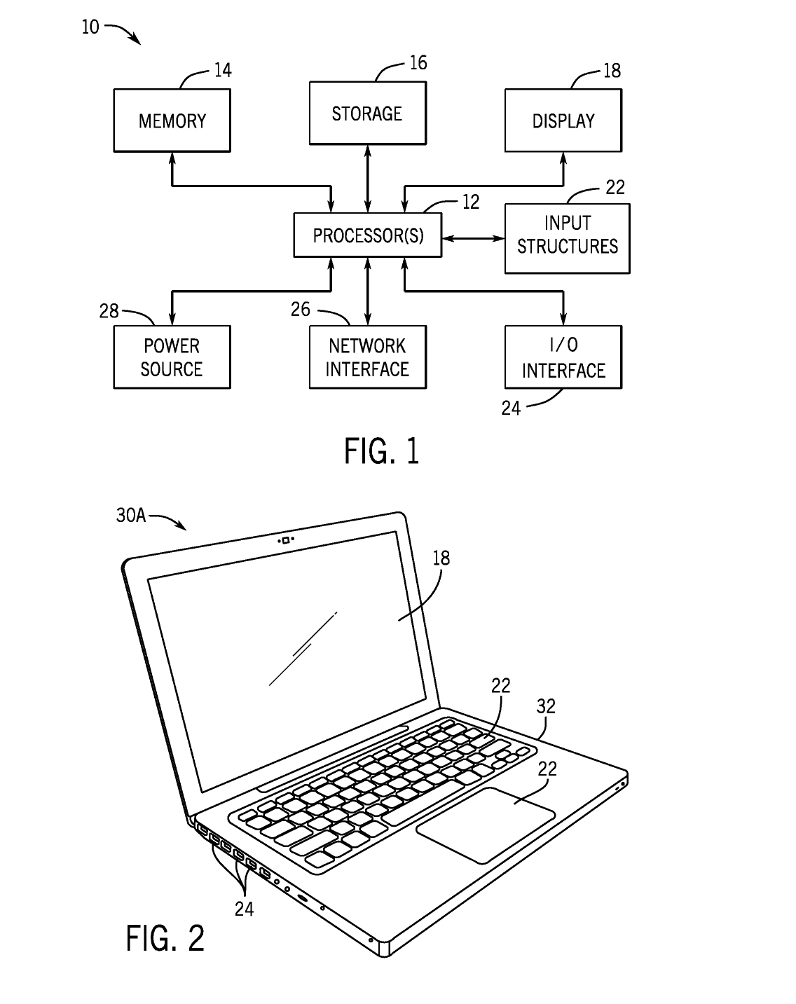

With the preceding in mind, a general description of suitable electronic devices that may include and use the capacitor structures described herein. FIG. 1 is a block diagram of an electronic device 10, in accordance with an embodiment of the present disclosure. The electronic device 10 may include, among other things, one or more processor(s) 12, memory 14, storage or nonvolatile memory 16, a display 18, input structures 22, an input/output (I/O) interface 24, network interface 26, and a power source 28. The various functional blocks shown in FIG. 1 may include hardware elements (including circuitry), software elements (including computer code stored on a computer-readable medium), or a combination of both hardware and software elements. Embodiments of the capacitor structures described herein may be used in the circuitry of the various functional blocks of FIG. 1 to improve a performance of software and hardware elements. It should be noted that FIG. 1 is merely one example of a particular implementation and is intended to illustrate the types of components that may be present in electronic device 10.

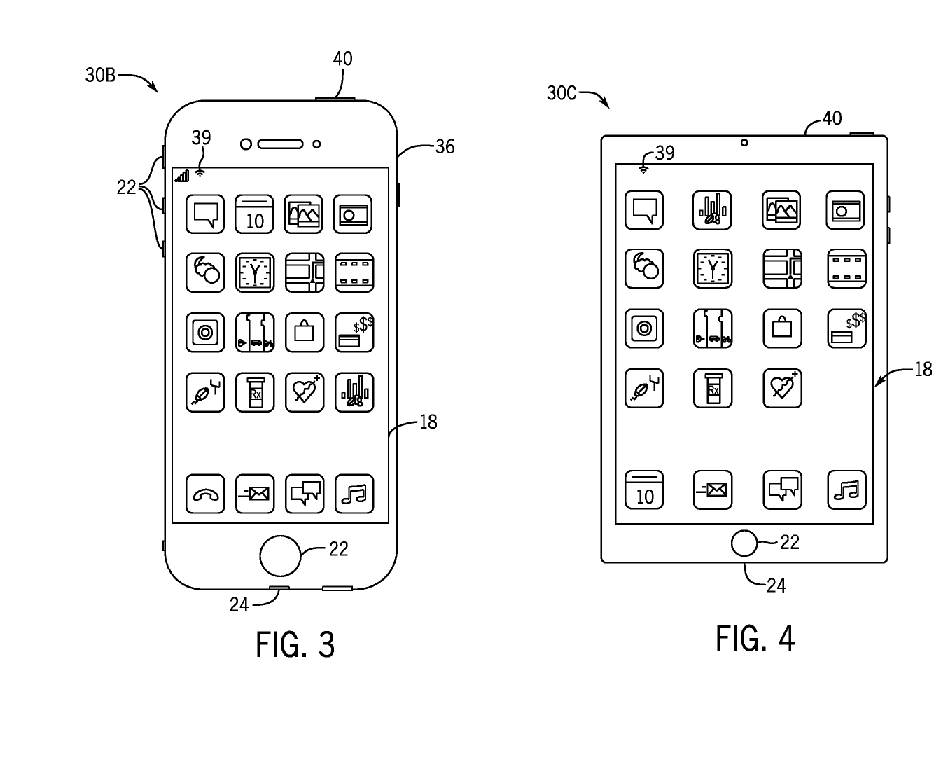

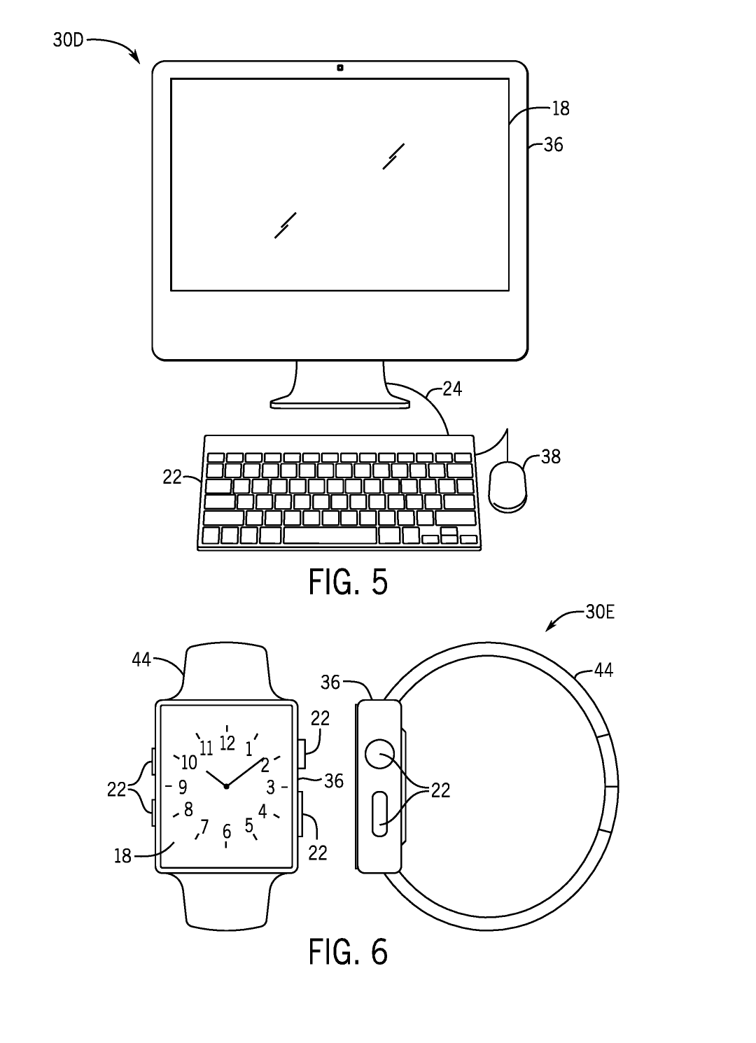

By way of example, the electronic device 10 may represent a block diagram of a notebook computer 30A depicted in FIG. 2, handheld devices 30B, 30C depicted in FIG. 3 and FIG. 4, a desktop computer 30D depicted in FIG. 5, a wearable electronic device 30E depicted in FIG. 6, or similar devices. It should be noted that the processor(s) 12 and/or other data processing circuitry may be generally referred to herein as “data processing circuitry.” Such data processing circuitry may be embodied wholly or in part as software, firmware, hardware, or any combination thereof. Furthermore, the data processing circuitry may be a single contained processing module or may be incorporated wholly or partially within any of the other elements within the electronic device 10.

In the electronic device 10 of FIG. 1, the processor(s) 12 and/or other data processing circuitry may be operably coupled with the memory 14 and the nonvolatile storage 16 to perform various algorithms. Such programs or instructions executed by the processor(s) 12 may be stored in any suitable article of manufacture or computer program product that includes one or more tangible, computer-readable media at least collectively storing the instructions or routines, such as the memory 14 and the nonvolatile storage 16. The memory 14 and the nonvolatile storage 16 may include any suitable articles of manufacture for storing data and executable instructions, such as random-access memory, read-only memory, rewritable flash memory, hard drives, and optical discs. Moreover, programs (e.g., an operating system) encoded on the memory 14 or the nonvolatile storage 16 may also include instructions that may be executed by the processor(s) 12 to allow the electronic device 10 to provide various functionalities.

In certain embodiments, the display 18 may be a liquid crystal display (e.g., LCD), which may allow users to view images generated on the electronic device 10. In some embodiments, the display 18 may include a touch screen, which may allow users to interact with a user interface of the electronic device 10. Furthermore, it should be appreciated that, in some embodiments, the display 18 may include one or more light emitting diode (e.g., LED, OLED, AMOLED, etc.) displays, or some combination of LCD panels and LED panels.

The input structures 22 of the electronic device 10 may allow a user to interact with the electronic device 10 (e.g., pressing a button to increase or decrease a volume level). The I/O interface 24 may allow electronic device 10 to interface with various other electronic devices. The I/O interface 24 may include various communications interfaces, such as universal serial bus (USB) ports, serial communications ports (e.g., RS232), Apple's Lightning® connector, or other communications interfaces. The network interface 26 may also allow electronic device 10 to interface with various other electronic devices and may include, for example, interfaces for a personal area network (e.g., PAN), such as a Bluetooth network, for a local area network (e.g., LAN) or wireless local area network (e.g., WLAN), such as an 802.11x Wi-Fi network, and/or for a wide area network (e.g., WAN), such as a 3rd generation (e.g., 3G) cellular network, 4th generation (e.g., 4G) cellular network, or long term evolution (e.g., LTE) cellular network. The network interface 26 may include an interface for, for example, broadband fixed wireless access networks (e.g., WiMAX), mobile broadband Wireless networks (e.g., mobile WiMAX), asynchronous digital subscriber lines (e.g., ADSL, VDSL), digital video broadcasting-terrestrial (DVB-T) and its extension DVB Handheld (DVB-H), Ultra-Wideband (UWB), alternating current (AC) power lines, and so forth.

In some applications, input structures 22, the I/O interfaces 24 and/or network interfaces 26 may employ radiofrequency (RF) circuitry modules, such as high performance impedance matching circuits, resonator circuits, precision tank circuits, and other related modules that may be beneficial in wireless communication. These applications may benefit from the use of capacitors with reduced fringe losses, such as the MLCC structures described herein.

As further illustrated, the electronic device 10 may include a power source 28. The power source 28 may include any suitable source of power, such as a rechargeable lithium polymer (e.g., Li-poly) battery and/or an alternating current (e.g., AC) power converter. The power source 28 may be removable, such as replaceable battery cell.

In certain embodiments, the electronic device 10 may take the form of a computer, a portable electronic device, a wearable electronic device, or other type of electronic device. Such computers may include computers that are generally portable (e.g., such as laptop, notebook, and tablet computers) as well as computers that are generally used in one place (e.g., such as conventional desktop computers, workstations and/or servers). In certain embodiments, the electronic device 10 in the form of a computer may be a model of a MacBook®, MacBook® Pro, MacBook Air®, iMac®, Mac® mini, or Mac Pro® available from Apple Inc. By way of example, the electronic device 10, taking the form of the notebook computer 30A, is illustrated in FIG. 2 in accordance with an embodiment of the present disclosure. The depicted computer 30A may include a housing or enclosure 32, a display 18, input structures 22, and ports of the I/O interface 24. In one embodiment, the input structures 22 (e.g., such as a keyboard and/or touchpad) may be used to interact with the computer 30A, such as to start, control, or operate a GUI or applications running on computer 30A. For example, a keyboard and/or touchpad may allow a user to navigate a user interface or application interface displayed on display 18.

FIG. 3 depicts a front view of a handheld device 30B, which represents an embodiment of the electronic device 10. The handheld device 30B may represent, for example, a portable phone, a media player, a personal data organizer, a handheld game platform, or any combination of such devices. By way of example, the handheld device 30B may be a model of an iPod® or iPhone® available from Apple Inc. of Cupertino, Calif. FIG. 4 depicts a front view of another handheld device 30C, which represents another embodiment of the electronic device 10. The handheld device 30C may represent, for example, a tablet computer, or one of various portable computing devices. By way of example, the handheld device 30C may be a tablet-sized embodiment of the electronic device 10, which may be, for example, a model of an iPad® available from Apple Inc. of Cupertino, Calif.

The handheld devices 30B and 30C may each include similar components. For example, an enclosure 36 may protect interior components from physical damage. Enclosure 36 may also shield the handheld devices 30B and 30C from electromagnetic interference. The enclosure 36 may surround the display 18, which may display indicator icons 39. The indicator icons 39 may indicate, among other things, a cellular signal strength, Bluetooth connection, and/or battery life. The I/O interfaces 24 may open through the enclosure 36 and may include, for example, an I/O port for a hard wired connection for charging and/or content manipulation using a connector and protocol, such as the Lightning connector provided by Apple Inc., a universal serial bus (e.g., USB), one or more conducted radio frequency connectors, or other connectors and protocols.

User input structures 22, 40, in combination with the display 18, may allow a user to control the handheld devices 30B or 30C. For example, the input structure 40 may activate or deactivate the handheld device 30B or 30C, one of the input structures 22 may navigate a user interface of the handheld device 30B or 30C to a home screen, a user-configurable application screen, and/or activate a voice-recognition feature of the handheld device 30B or 30C, while other of the input structures 22 may provide volume control, or may toggle between vibrate and ring modes. In the case of the handheld device 30B, additional input structures 22 may also include a microphone may obtain a user's voice for various voice-related features, and a speaker to allow for audio playback and/or certain phone capabilities.

Turning to FIG. 5, a computer 30D may represent another embodiment of the electronic device 10 of FIG. 1. The computer 30D may take any suitable form of computer, such as a desktop computer, a server, or a notebook computer, but may also be a standalone media player or video gaming machine. By way of example, the computer 30D may be an iMac®, a MacBook®, or other similar device by Apple Inc. It should be noted that the computer 30D may also represent a personal computer (e.g., PC) by another manufacturer. A similar enclosure 36 may be provided to protect and enclose internal components of the computer 30D such as a dual-layer display. In certain embodiments, a user of the computer 30D may interact with the computer 30D using various peripheral input devices, such as input structures 22 (e.g., the keyboard or mouse 38), which may connect to the computer 30D via a wired I/O interface 24 and/or wireless I/O interface.

Similarly, FIG. 6 depicts a wearable electronic device 30E representing another embodiment of the electronic device 10 of FIG. 1 that may be configured to operate using the techniques described herein. By way of example, the wearable electronic device 30E, which may include a wristband 44, may be an Apple Watch® by Apple, Inc. However, in other embodiments, the wearable electronic device 30E may include any wearable electronic device such as, for example, a wearable exercise monitoring device (e.g., pedometer, accelerometer, heart rate monitor), or other device by another manufacturer. The display 18 of the wearable electronic device 30E may include a touch screen (e.g., LCD, OLED display, active-matrix organic light emitting diode (e.g., AMOLED) display, and so forth), which may allow users to interact with a user interface of the wearable electronic device 30E.

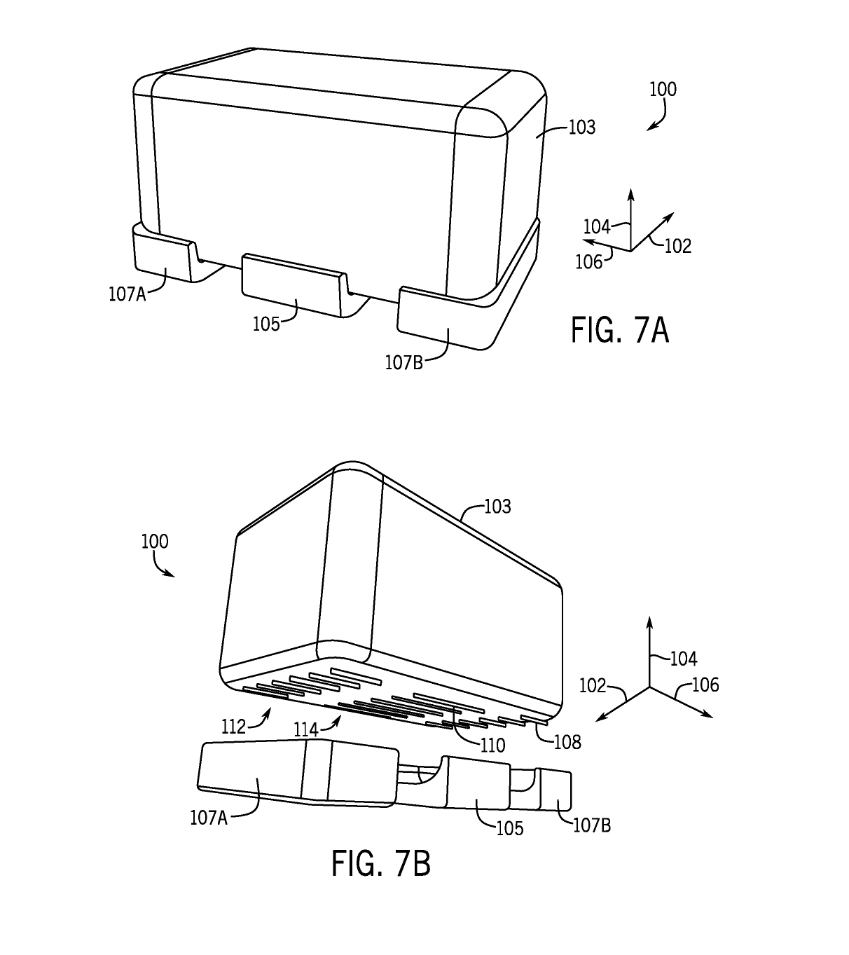

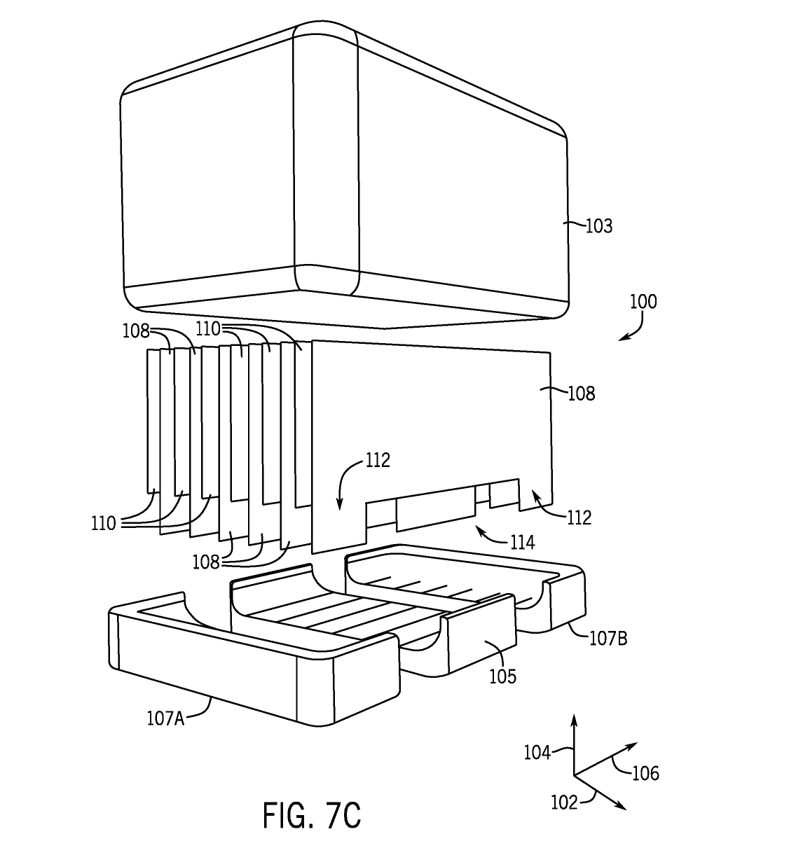

The devices illustrated in FIGS. 1, 2, 3, 4, 5, and 6 may employ capacitor structures and electrodes that may be used to couple to metallic terminations located in the bottom of the component, such as the ones described below. In the figures illustrating embodiments of the capacitors, such as in FIGS. 7A, 7B, 7C, 8A, 8B, 8C, 9A, 9B, 10A, 10B, 10C, 10D, 11A, 11B, 11C, 11D, and 11E, reference is made to directions and orientations of structures of the capacitor with reference to a three dimensional axis defined by a horizontal direction 102, a vertical direction 104, and a transversal direction 106. In some embodiments, a vertical direction 104 may refer to a direction perpendicular to a horizontal plane formed by a horizontal direction 102, and a transversal direction 106. Moreover, in certain embodiments, the electrode surfaces may be perpendicular to the horizontal plane formed by the horizontal direction 102 and the transversal direction 106. In embodiments where the capacitor may be coupled (e.g., mounted) to a printed circuit board (PCB), the horizontal plane formed by horizontal direction 102 and transversal direction 106 may be parallel to the mounting surface of the PCB. Moreover, references to a bottom of a capacitor relates to the side of the capacitor that may be in contact or in close proximity with the mounting surface of the PCB.

The structures illustrated in FIGS. 7A, 7B, and 7C, illustrate a capacitor 100 having bottom terminations coupled to the electrodes. Capacitor 100 may be an MLCC capacitor with an outer case 103. Capacitor 100 may provide a capacitive connection between termination 105 and the split terminal formed by termination 107A and 107B. In a capacitor with split terminals, different terminations may form a single capacitor terminal. In such designs, PCB connectors for each of termination of the split terminal may be shorted. As illustrated in the perspective view of FIG. 7A, termination 105 and 107A and 107B are located in the bottom of the capacitor 100. The partially exploded view in FIG. 7B illustrate the electrodes 108 that may be directly coupled to termination 107A and 107B, and electrode 110 that may be directly coupled to termination 105. The coupling between the electrode 108 and terminations 107A and 107B takes place through tabs 112 exposed through case 103 at the bottom of the capacitor 100. Similarly, coupling between electrode 110 and termination 105 takes place through tabs 114 exposed through case 103 at the bottom of the capacitor 100.

The exploded view in FIG. 7C illustrates the organization of electrodes and the connections of capacitor 100. Case 103 of capacitor 100 includes a first set of electrodes 108 that may be coupled to the terminations 107A and 107B. Note that every electrode 108 couples with both terminations 107A and 107B, forming thus a split terminal. Capacitor 100 also includes a second set of electrodes 110 that may be coupled to termination 105. Note also that a large portion of the area of electrodes 108 and 110 are aligned, forming a capacitive coupling through a dielectric disposed between the electrodes. Note further that, at the bottom, tabs 112 of electrode 108 are not aligned to tabs 114 of electrode 110, which allows enough clearance for proper coupling with terminations 105, 107A, and 107B.

The presence of tabs 112 and 114 at the bottom of the capacitor 100 provide short current paths from terminations 105, 107A, and 107B into the electrodes. As discussed above, these short current paths may provide improve electrical characteristics to capacitor 100 by mitigating line induction issues and/or current crowding points. Note further that terminations 105, 107A, and 107B present minor extensions to the side of case 103. These extensions may allow a coupling between capacitor 100 and printed circuit board with increased cross-section in the solder connection.

Due to the design of the capacitor 100, electrons may be able to access all electrodes simultaneously and, as a result, inter-electrode inductance is reduced. Furthermore, the proximity between the electrode and the termination provided by the tabs 112 and 114, finite cover layer inductance (e.g., inductance due to the gap between the electrode and the cover layer) is substantially reduced.

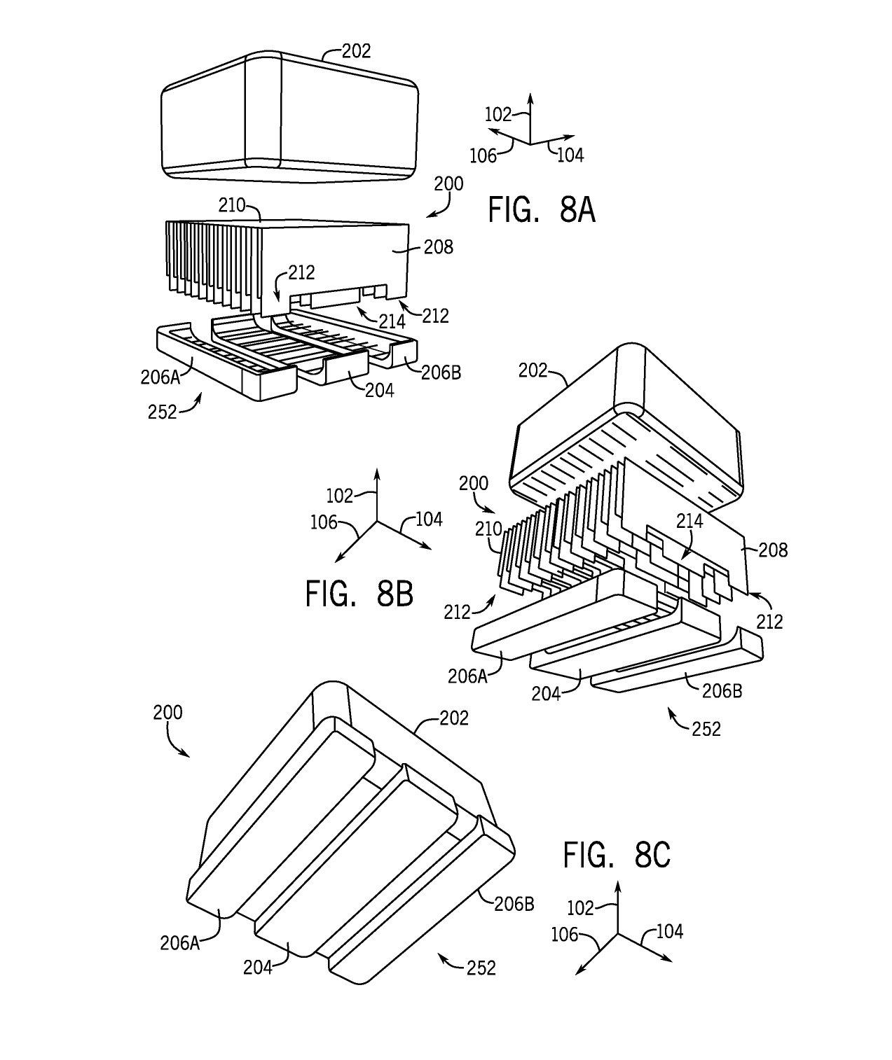

Capacitor 200 illustrated in the views presented in FIGS. 8A, 8B, and 8C, illustrate a capacitor similar to capacitor 100, having a square-shaped bottom. As shown in the exploded views of FIGS. 8A and 8B, capacitor 200 has a case 202 that is attached to a termination 204 and a split terminal formed by terminations 206A and 206B. Capacitor 200 may also have a set of electrodes 208 that may be coupled to terminations 206A and 206B, and a second set of electrodes 210 that may be coupled to termination 204. Electrodes 208 may be coupled to terminations 206A and 206B through tabs 212, whereas electrodes 210 may be coupled to termination 204 through tab 214.

As illustrated in the bottom view of FIG. 8C, capacitor 200 may have a bottom shape 252 that is closer to a square, by contrast to the rectangular format of capacitor 100. This shape may be achieved by increasing the number of electrodes used. For example, capacitor 200 may have twice as many electrodes as capacitor 100. In such design, the height of the capacitor may be decreased, without reduction of the capacitive coupling area. This may decrease further the current paths without changes to the capacitor characteristics.

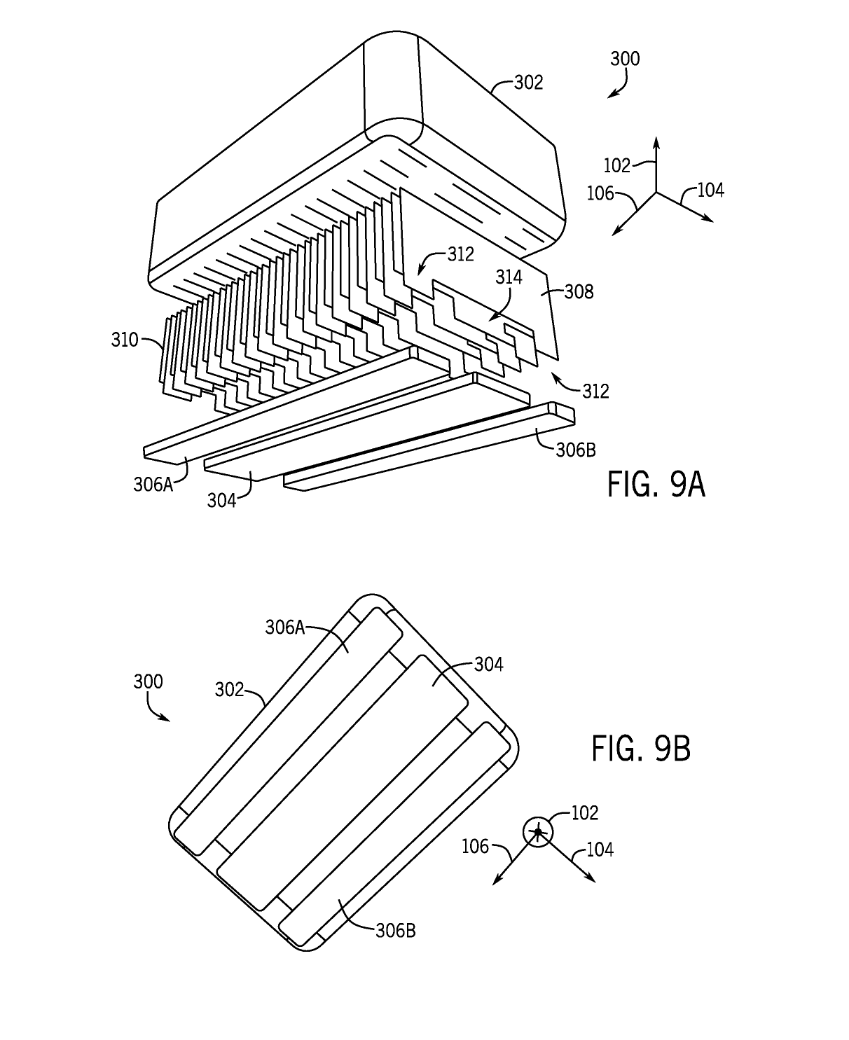

Another design for a capacitor 300 having bottom terminations is illustrated in exploded view of FIG. 9A and the corresponding bottom view of FIG. 9B. Capacitor 300 may have a case 302, a first terminal with termination 304 and a second terminal with split terminations 306A and 306B. Capacitive interfaces may be formed between a first set of electrodes 308 and a second set of electrodes 310. Electrodes 308 may be coupled to terminations 306A and 306B via tabs 312, and electrodes 310 may be coupled to termination 304 via tabs 314. Similar to capacitors 100 and 200, the aligned regions of electrodes 308 and 310 provide the capacitive interfaces, while tabs 312 and 314 provide clearance for proper coupling to the terminations 304, 306A, and 306B.

Note that in capacitor 300, terminations 304, 306A, and 306B of capacitor 300 are limited to the bottom side of the capacitor and do not extend to the side of the case 302. This arrangement is in contrast with capacitors 100 and 200, as discussed above. While decreasing the cross section in the solder region, it may also lead to decrease in the distances of the multiple current paths flowing from a PCB into the electrodes. As a result, termination limited to the bottom of case 302 may improve the Q factor of capacitor 300.

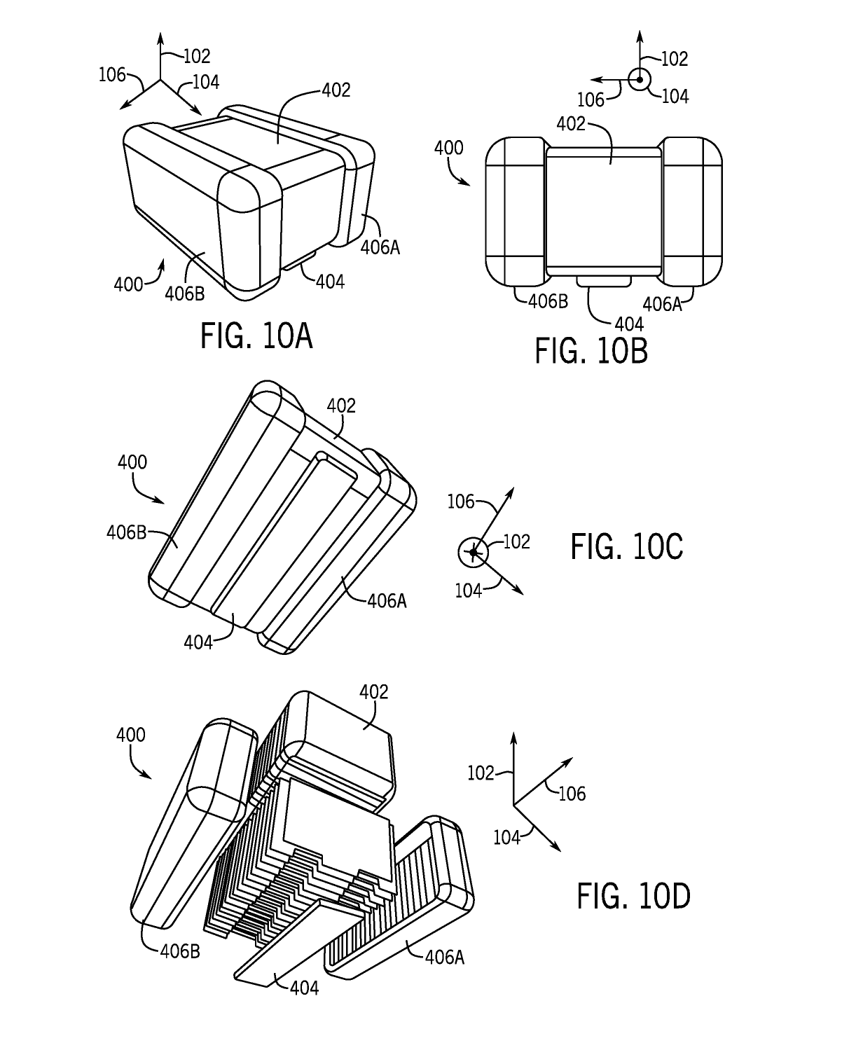

While capacitor 300 limited the termination to the bottom of the case 302, capacitor 400, illustrated in FIGS. 10A, 10B, 10C, and 10D, provide terminations that extend to an entire side of the capacitor. Capacitor 400 has a case 402, a first terminal with termination 404 and a second terminal with split terminations 406A and 406B. Note that terminations 406A and 406B cover entire sides of case 402. The capacitive interface of capacitor 400 is established between electrodes 408 and 410, as illustrated in FIG. 10D. Electrodes 410 may couple to the bottom termination 404 through tabs 414. By contrast, electrodes 408 may couple to terminations 406A and 406B through side extensions 416 as well as through tabs 418 disposed in the bottom corners of the electrodes. Note that case 402 may have openings to accommodate the coupling between electrodes 408 and terminations 406A and 406B through the side extensions. The presence of terminations 406A and 406B in the side of case 402 may increase the cross-section for soldering, reducing thus the ESR of capacitor 400.

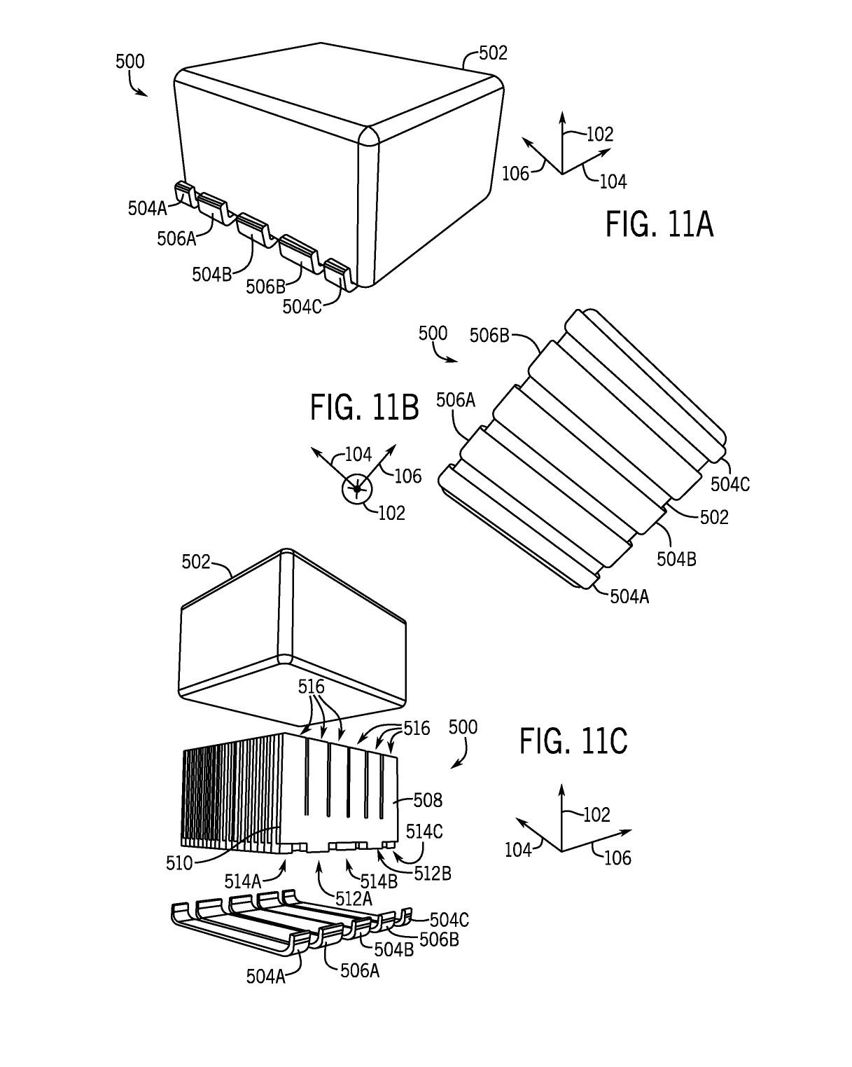

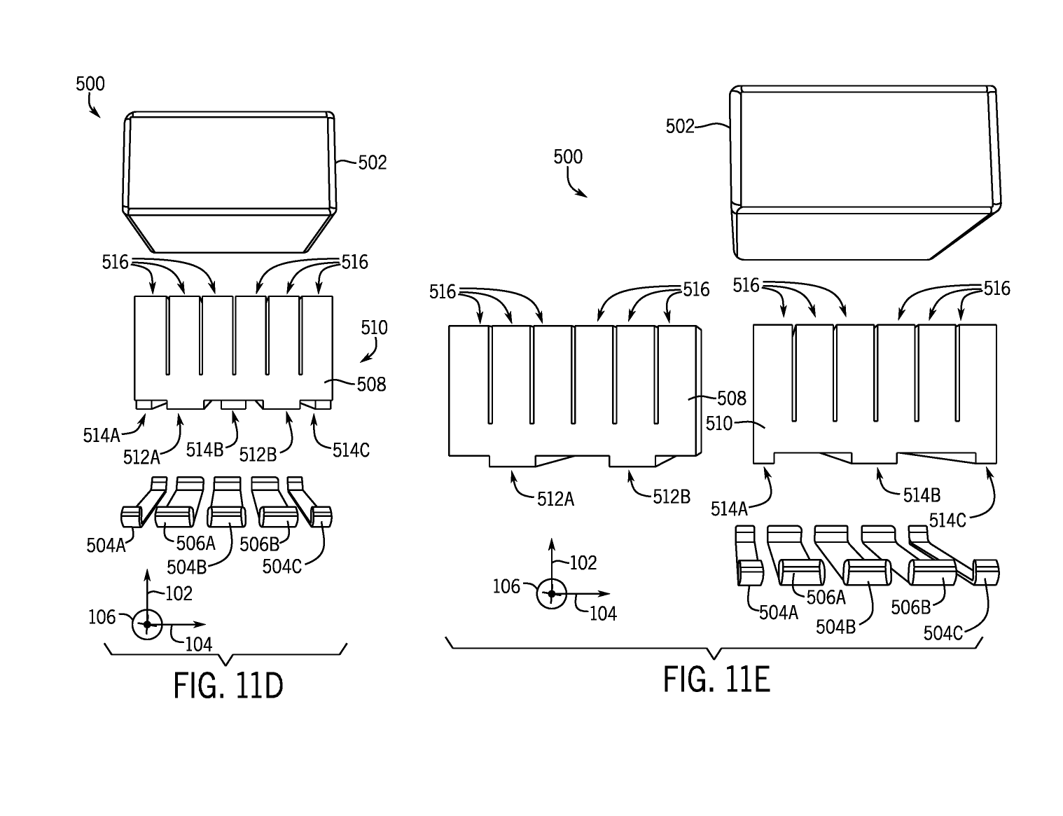

Capacitor 500, illustrated in FIGS. 11A, 11B, 11C, 11D, and 11E illustrate an embodiment in which both terminals of the capacitor may have split terminations. Capacitor 500 may have a case 502. Capacitor 500 may also have a first terminal formed by split terminations 504A, 504B, 504C and a second terminal formed by split terminations 506A and 506B. The terminations are disposed in the bottom of the capacitor 500, as illustrated in the bottom view of FIG. 11B, and may be coupled to the electrodes through tabs, as illustrated in exploded views of FIGS. 11C, 11D, and 11E. For example, electrodes 508 may be coupled to terminations 506A and 506B via tabs 512A and 512B, respectively. Similarly, electrodes 510 may be coupled to terminations 504A, 504B, and 504C via tabs 514A, 514B, and 514C, respectively. Note that, as seen in FIG. 11D, electrodes 508 and 510 may be aligned in most of its surface, with the exception of the regions of tabs 512A, 512B, 514A, 514B, or 514C. The modified exploded view of FIG. 11E illustrates an offset view of electrodes 508 to illustrate the alignment between the set of electrodes 508 and 510 that form the capacitive coupling. It should also be noted that electrodes 508 and 510 may have a pitchfork shape, with lanes 516 for directing currents into and out of the electrodes.

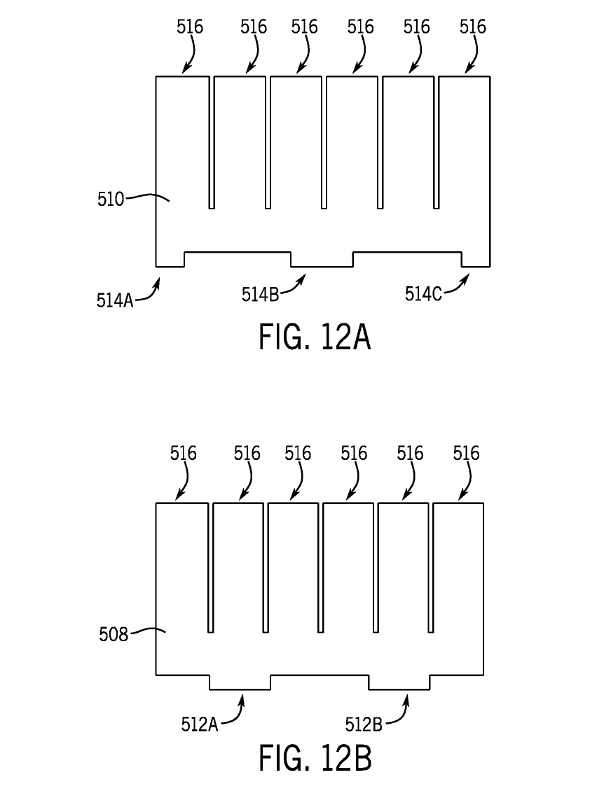

The pitchfork-shaped electrodes are illustrated in FIGS. 12A and 12B. FIG. 12A illustrates electrode 510 having tabs 514A, 514B, and 514C and lanes 516, while FIG. 12B illustrates electrode 508 with tabs 512A and 512B. As electrons move between the tabs and the surface of the electrodes, the presence of lanes 516 provide a direction for the current path flow. As a result, lanes 516 may lead to a more ordered flow of charges into and out of the electrode, decreasing effects that may arise from undesired inductances in the electrode surface. Note further that, in a capacitive system, as currents flow into lanes 516 of electrode 508, simultaneous currents flow out of lanes 516 of electrode 510. The result of the opposite currents may lead to canceling self-inductances between the electrodes during operation, which may improve the Q factor of the capacitor.

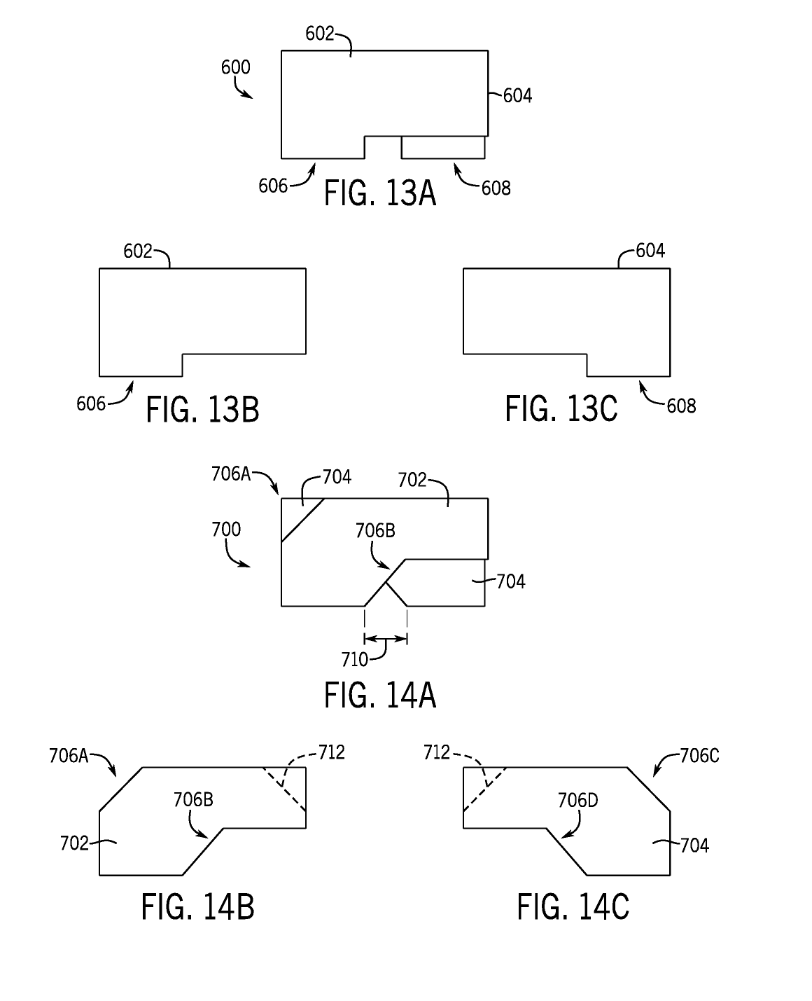

Capacitors 100, 200, 300, 400, and 400 discussed above provide layouts having terminals with a split termination. While the 3-termination and 5-termination designs illustrated above may have shorter current loops, a 2-termination design may be more convenient to be used in certain circuit layouts. Capacitive coupling 600 illustrated in FIGS. 13A, 13B, and 13C, and capacitive coupling 700 illustrated in FIGS. 14A, 14B, and 14C illustrate electrode designs that may be used to fabricate capacitors having terminals with monolithic (i.e., non-split) bottom terminations. FIG. 13A illustrates a capacitive coupling 600 between a first electrodes 602 and a second electrode 604. Electrode 602 may present a bottom tab 606 for coupling with a first terminal at the bottom of a capacitor. Similarly, electrode 604 may present a bottom tab 608 for coupling with a second terminal at the bottom of the capacitor. A capacitor may be constructed intercalating a first set of electrodes similar to 602 with a second set of electrodes similar to 604, and coupling with metallic terminations at the bottom of the case, as illustrated in capacitors 100, 200, 300, and 400 described above.

Electrodes 602 and 604 may present an elongated current path through the top corners of the electrode plates, and through the corners formed by the tabs 606 and 608, respectively. Electrodes 702 and 704 that form capacitive coupling 700 illustrated in FIGS. 14A, 14B, and 14C may have modifications that may reduce the elongated current paths presented in capacitive coupling 600. Electrode 702, illustrated also in FIG. 14B may have a corner notch 706A in the top corner of the electrode plate, and a second notch 706B in the corner formed by the connection to the electrode. Electrode 704 may present notch 706C in the top corner of the electrode plate and notch 706D in the corner formed by the connection to the electrode.

Based on the angle and the dimension of notches 706A, 706B, 706C, and 706D, separation 710 between the terminations may be adjusted. A decreased separation between the terminations may allow an increase in the capacitive coupling at the surface of electrodes 702 and 704. Decreased separation may also lead to increase in the cross-section of the current path area, leading to decreased ESR. Note that a further notch may be placed in electrodes 702 and 704 at the line 712 in electrodes 702 and 704. This additional notch may be included in order to decrease areas in an electrode that do not provide capacitive coupling, as there may be misalignment between electrodes in the regions of notch 706A and 706C.

Note that capacitors designed employing the methods described above may have a rated voltage ranging between 1V and 100V, and a rated capacitance between 0.1 pF and 1000 μF. Moreover, the capacitors may have a Q factor that is suitable for utilization in high-frequency circuitry. The capacitor may perform under alternating current (AC) signals ranging from 10 HZ to 100 GHz. Capacitors described herein may have dimensions (e.g., width, length, height) ranging from 0.1 mm to 1 cm. The thickness of each ceramic layer may be between 50 nm-1 μm. With respect to the pitchfork layout in electrodes 508 and 510, the pitch between neighboring lanes may be in a range between 10 μm-1 mm, and the gap between neighboring lanes may be in a range between 1 μm-100 μm.

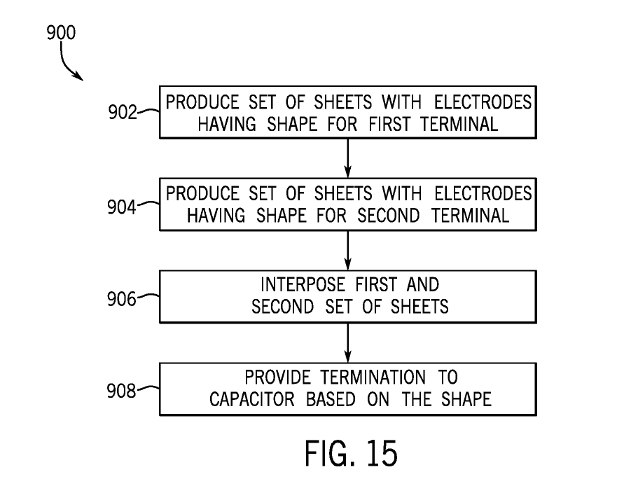

With the foregoing in mind, method 900 in FIG. 15 provides a process for fabrication of capacitors and/or capacitive structures such as the ones illustrated above. In a process 902, ceramic sheets (e.g., green sheets) may be stenciled to form electrodes using a conductive paste or material. The conductive material may be produced from copper, nickel, silver, a copper alloy, a nickel alloy, or a silver alloy, or any other metal alloys. Ceramic sheets may have any of the shapes illustrated in capacitors 100, 200, 300, 400, or 500 or in capacitive couplings 600 and 700. Note that extensions and tab structures may be created by stenciling a region close to the boundary of the green sheet, while notch structures and lanes may be created by leaving appropriate regions of the green sheet without the conductive material. In some implementations, a conductive sheet may also be produced and cut in the shape of the electrodes. All sheets in the first set of sheets may be similar to each other, as illustrated above.

A second set of sheets having corresponding electrode shape may be produced in a second process 904. As in process 902, ceramic sheets may be stenciled to form the electrodes that may form capacitive coupling with the first set of electrodes. Note that care should be taken such that the electrodes of the second set of sheets line up with electrodes in the first set sheets, as illustrated in the capacitors above. The first and the second set of ceramic sheets may be then interposed to create a stack of capacitive interfaces illustrated above (process 906). Each sheet (e.g., layer) may of one set may be interposed between two layers of the other set. The interposed stack may be pressed to form a capacitive structure such as the ones described above. Since the electrodes are formed in the surface of ceramic sheets, the ceramic material may form the dielectric for the capacitive coupling. Ceramic sheets may be formed from stable ceramic materials, or ultra-stable ceramic materials.

After process 906, an external case may be added to the ceramic capacitor device. Moreover, tabs and/or side extensions may be exposed in the bottom of the device or side of the device (e.g., tabs 112 and 114 in FIG. 7B). Metallic terminations may be placed on the surfaces of the capacitor case (process 908) to couple the multiple electrodes of the same set, and to provide a termination for mounting to a circuit board. Capacitors 100, 200, 300, 400, and 500 provide examples of terminations that may be implemented.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

What is claimed is:

1. A capacitor, comprising:
a first set of layers, each layer of the first set of layers comprising a first electrode that comprises a first tab disposed in a bottom of each first electrode and coupled to a first termination of the capacitor; and
a second layer interposed between two layers of the first set of layers, wherein the second layer comprises a second electrode having a second tab disposed in the bottom of the second electrode and coupled to a second termination of the capacitor.

2. The capacitor of claim 1, wherein the second layer comprises a third tab that is coupled to a third terminal, and wherein the second termination and the third termination form a single terminal of the capacitor.

3. The capacitor of claim 1, wherein the second termination is disposed along the bottom and along a portion of a side of the capacitor.

4. The capacitor of claim 1, wherein the second termination is covers an entire side of the capacitor.

5. The capacitor of claim 4, wherein the second electrode comprises side extensions that substantially contacts the second termination.

6. The capacitor of claim 1, wherein a shape of a bottom of the capacitor is substantially square.

7. The capacitor of claim 1, comprising:
a first capacitor terminal that comprises the first termination and a third termination; and
a second capacitor terminal that comprises the second termination, a fourth termination, and a fifth termination;
wherein each first electrode of the first set of layers is directly coupled to the first capacitor terminal, and the second electrode is directly coupled to the second capacitor terminal.

8. The capacitor of claim 1, wherein each first electrode comprises a first plurality of lanes, and wherein the second electrode comprises a second plurality of lanes that is aligned with the first plurality of lanes.

9. The capacitor of claim 1, wherein each first electrode and the second electrode comprises copper, nickel, silver, a copper alloy, a nickel alloy, or a silver alloy, or any combination thereof.

10. The capacitor of claim 1, wherein a rated voltage of the capacitor is approximately between 1V and 100V.

11. The capacitor of claim 1, wherein a rated capacitance of the capacitor is approximately between 0.1 pF and 1000 μF.

12. The capacitor of claim 1, wherein the capacitor comprises a multi-layer ceramic capacitor having a stable ceramic material, an ultra-stable ceramic material, or any combination thereof as a dielectric therein.

13. An electrical device comprising:
an electrical circuit that comprises a capacitor electrically coupled to the electrical circuit, the capacitor comprising:
a first set of layers, each layer of the first set of layers comprising a first electrode that comprises a first tab disposed in a bottom of each first electrode and coupled to a first termination of the capacitor; and
a second set of layers, at least one of the second set of layers interposed between two layers of the first set of layers, and each layer comprising a second electrode having a second tab disposed in a bottom of each second electrode and coupled to a second termination of the capacitor;
wherein the first and the second terminations are located along a bottom of the capacitor.

14. The electrical device of claim 13, wherein each first electrode of the first set of layers comprises a third tab disposed in the bottom of each first electrode and coupled to a third termination of the capacitor.

15. The electrical device of claim 13, wherein the electrical circuit induces alternating current (AC) signals in the capacitor.

16. The electrical device of claim 15, wherein a frequency of the AC signals is substantially between 10 Hz and 100 GHz.

17. A method to produce multilayer ceramic capacitors, comprising:
stenciling a first ceramic sheet with a conductive material to produce a first electrode, wherein the first electrode comprises a first tab;
stenciling a second ceramic sheet with the conductive material to produce a second electrode, wherein the second electrode comprises a second tab, and a layout of the second electrode corresponds to a layout of the first electrode; and
stacking the first ceramic sheet and the second ceramic sheet to create a capacitive coupling between the first electrode and the second electrode and exposing the first tab and the second tab at a bottom of the stack.

18. The method of claim 17, wherein stenciling the first sheet comprises producing a plurality of lanes in the first electrode, and wherein stenciling the second sheet comprises producing a plurality of lanes in the second electrode.

19. The method of claim 17, comprising attaching a metallic termination along the bottom of the multilayer ceramic capacitor, wherein the metallic termination is coupled to first tab.

20. The method of claim 17, wherein stenciling the first electrode comprises a side extension, and wherein the method comprises attaching a metallic termination along the bottom and along an entire side of the multilayer ceramic capacitor, wherein the metallic termination is coupled to the first tab and the side extension.
